(19) United States
(12) Patent Application Publication
(10) Pub. No.: US 2019/0340308 A1
(43) Pub. Date: Nov. 7, 2019

(54) METHOD FOR PARTIAL UPDATING

(71) Applicants: Tao WANG, Shanghai (CN); Shing Chi HSU, Cypress, CA (US); Siemens Product Lifecycle Management Software Inc., Plano, TX (US)

(72) Inventors: Shingchi HSU, Cypress, CA (US); Tao WANG, Shanghai (CN)

(73) Assignee: Siemens Product Lifecycle Management Software Inc., Plano, TX (US)

(21) Appl. No.: 16/479,005

(22) PCT Filed: Jan. 20, 2017
(86) PCT No.: PCT/CN2017/071881

§ 371 Date: Jul. 18, 2019

(51) Int. Cl. G06F 17/50

(52) U.S. Cl. CPC G06F 17/50

(57) ABSTRACT

Methods are for partial updating a graph's layout for nodes and their respective connections when a change to the graph occurs, each node being linked with another node by a connecting line and the connecting line being attached to the respective nodes by using a port on the node. A method of an embodiment includes receiving a user input of an update of the layout. The update includes adding a node or a connecting line, moving a node or a connecting line, or resiting a node. The method of an embodiment further includes positioning the port only on the node affected by the update and on the node connected with the affected one. The method of an embodiment further includes routing the connecting line between the affected node and the node connected.

### PRIORITY STATEMENT

This application is the national phase under 35 U.S.C. § 371 of PCT International Application No. PCT/CN2017/071881 which has an International filing date of Jan. 20, 2017, which designated the United States of America, the entire contents of which are hereby incorporated herein by reference.

### FIELD

Embodiments of the present application are directed, in general, to computer-aided design (“CAD”), visualization, and manufacturing systems, product lifecycle management (“PLM”) systems, and similar systems, that manage data for products and other items (collectively, “Product Data Management” systems or PDM systems). Various embodiments are particularly related to CAD systems and processes for composite parts.

### BACKGROUND

Product data management (PDM) systems manage product lifecycle management (PLM) systems and other data. Improved systems are desirable.

### SUMMARY

Various disclosed embodiments include methods for partial updating a graph's layout for nodes and their respective connections when a change to the graph occurs, each node is linked with another node by a connecting line, the connecting line is attached to the respective nodes by using a port on the node. A method includes receiving a user input of an update of the layout. The update includes adding a node or a connecting line, moving a node or a connecting line, or resizing a node. The method further includes positioning the port only on the node affected by the update and on the node connected with the affected one. The method further includes routing the connecting line between the affected node and the node connected.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

At least one embodiment is directed to a method for partial updating of a layout of a graph for a plurality of nodes, and respective connections between the plurality of nodes, upon a change to the graph occurring, each node of the plurality of nodes being linked with another node of the plurality of nodes by a respective connecting line, the respective connecting line being attached to respective linked nodes by using a port on a respective one of the linked nodes, the method, performed by a data processing system, comprising:

receiving a user input of an update of the layout, the update including adding a node or a connecting line, moving a node or a connecting line, or resizing a node;

positioning the port only on a node affected by the update received, and on a node connected with the node affected by the update received; and

routing the connecting line, between the node affected by the update received and the node connected, based on the position of the port updated by the positioning

At least one embodiment is directed to a data processing system comprising:

a processor; and

an accessible memory, the processor configured to partial update a layout of a graph for a plurality of nodes and respective connections between nodes of the plurality of nodes, upon a change to the graph occurring, each node of the plurality of nodes being linked with another node of the plurality of nodes by a respective connecting line, the respective connecting line being attached to respective nodes of the plurality of nodes, by using a port on one of the respective nodes, wherein, the processor is further configured to:

receive a user input of an update of the layout, the update including adding a node or a connecting line, moving a node or a connecting line, or resizing a node;

position the port only on the node affected by the update received and on the node connected with the node affected by the update received; and

route the connecting line between the node affected by the update received and the node connected based on the position of the port updated.

At least one embodiment is directed to a non-transitory computer-readable medium encoded with executable instructions that, when executed, cause one or more data processing systems to partially update a layout of a graph for a plurality of nodes and respective connections between the plurality of nodes, upon a change to the graph occurring, each node of the plurality of nodes being linked with another node of the plurality of nodes by a respective connecting line, the respective connecting line being attached to the respective linked nodes, by using a port on one of the respective linked nodes, wherein, the executable instructions, when executed, cause one or more data processing systems to:

receive a user input of an update of the layout, the update including adding a node or a connecting line, moving a node or a connecting line, or resizing a node;

position the port only on the node affected by the update received and on the node connected with the node affected by the update received; and

route the connecting line between the node affected by the update received and the node connected based on the position of the port updated.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates a flow chart of a method for partial updating a graph's layout in accordance with example embodiments, for example, by a PLM or PDM system;

FIG. 3 illustrates an example of a graph's layout;

FIGS. 4-7 illustrate examples of a graph before partial updating and after in accordance with disclosed embodiments;

FIG. 8 illustrates routing examples of a connecting line after partial updating in accordance with disclosed embodiments;

FIGS. 9-11 illustrate examples with wrong routing; and

FIGS. 12-13 illustrate routing examples of a connecting line after partial updating in accordance with disclosed embodiments.

### DETAILED DESCRIPTION OF THE EXAMPLE EMBODIMENTS

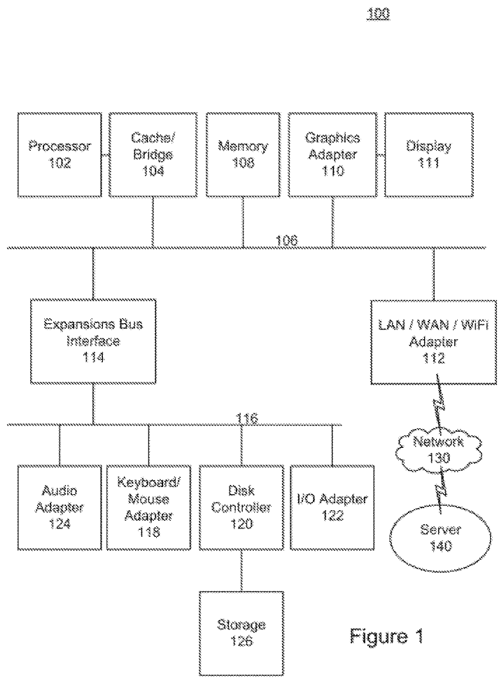

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to example non-limiting embodiments.

There is a layout type called Sorted Layout. Graphical elements spaced in an organized way are used to represent different items. For example, a node could represent a process, function or requirement, and a line could connect one node with another to show their connection. The connecting lines in the graph of the layout are orthogonal. The graphical elements could be placed in a structured and/or hierarchical way. It can also be positioned based on a process or as desired by a user.

Further modification of the graph in the layout is sometimes needed, for example, the operation of moving, resizing or adding one or more graphical elements in the layout. It is therefore necessary to provide methods to make partial updating of the layout which could keep the aesthetics of the graph but with less computational efforts.

Disclosed embodiments describe a method for partial updating a layout of nodes.

FIG. 1 illustrates a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

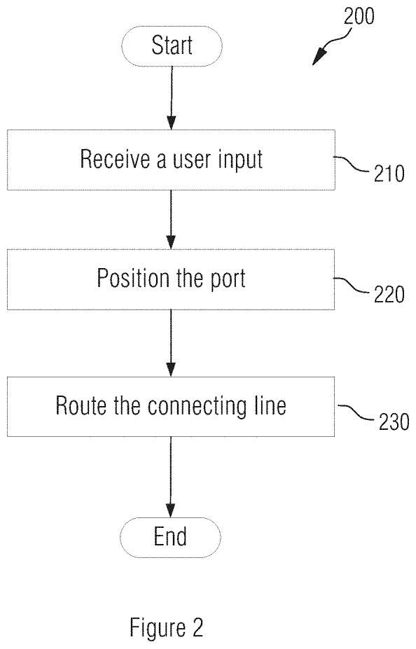

FIG. 2 illustrates a flow chart of a method 200 for partial updating a layout in accordance with example embodiments. Each of the blocks of the method 200 are now summarized and then described further herein. It will be appreciated that the various blocks described herein can be performed at different times and not necessarily serially. At block 210, the computer system receives a user input of an update of the layout, which includes adding a node or a connecting line, moving a node or a connecting line, or resizing a node. At block 220, the computer system positions the ports on the node affected by the update and the node which is connected to the affected node. At block 230, the computer system routes the connecting line between the affected node and the node connected based on the updated position of such ports.

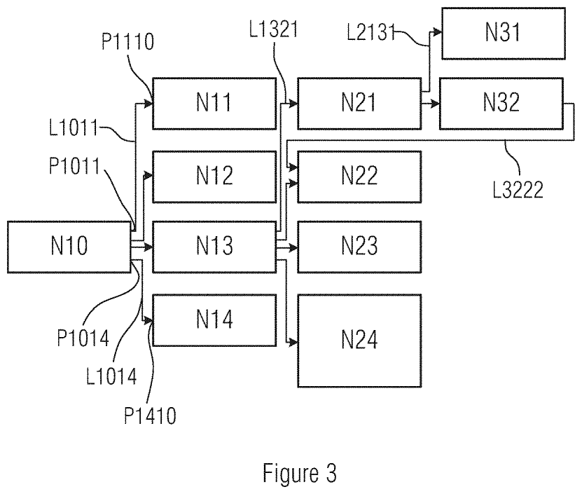

FIG. 3 illustrates an example of a layout. Nodes N10, N11, N12, N13, N14, N21, N22, N23, N24, N31, and N32 are in rectangles. It is possible to resize a node, for example, N24 was resized to be larger than the rest. Connecting lines are used to connect various nodes together. The connecting lines in the graph are orthogonal. For example, line L1321 is connecting N13 and N21, and line L2131 is connecting N21 and N31. It is also possible for multiple connections to run between nodes. For example, there are 4 lines connecting node N10 to other nodes, including L1011 and L1014.

Ports are the attachments between a connection and a node. The port could be in a special shape or even visually coincident with the connecting point of the line to a node. For example, line L1011 is connecting node N10 on the port P1011 on and node N11 on port P1110, and line L1014 is connecting node N10 on the port P1014 and node N14 on port P1410.

It is possible to set the extension direction of the layout. In FIG. 3, the layout is extended from left to right, it is appreciated that the layout could extend from right to left, from up to down, or from down to up.

The direction of the lines connecting a node to another node is dependent on the extension direction of the layout. In FIG. 3, the lines are always from the right side of the rectangle of a node (Source) and end on the left side of another node (Target), as with, for example, line L1011, L1014, L1321 and L2131. Even if the Source is on the right of a Target, the line should also start from the right side of the rectangle of the Source and end on the left side of the Target node, for example line L3222.

As described above, sometimes it is necessary to update the layout by adding, moving or resizing the graph elements, including the node, connecting line and port.

Various embodiments will be described in details regarding the different update due to the user (or other) input received.

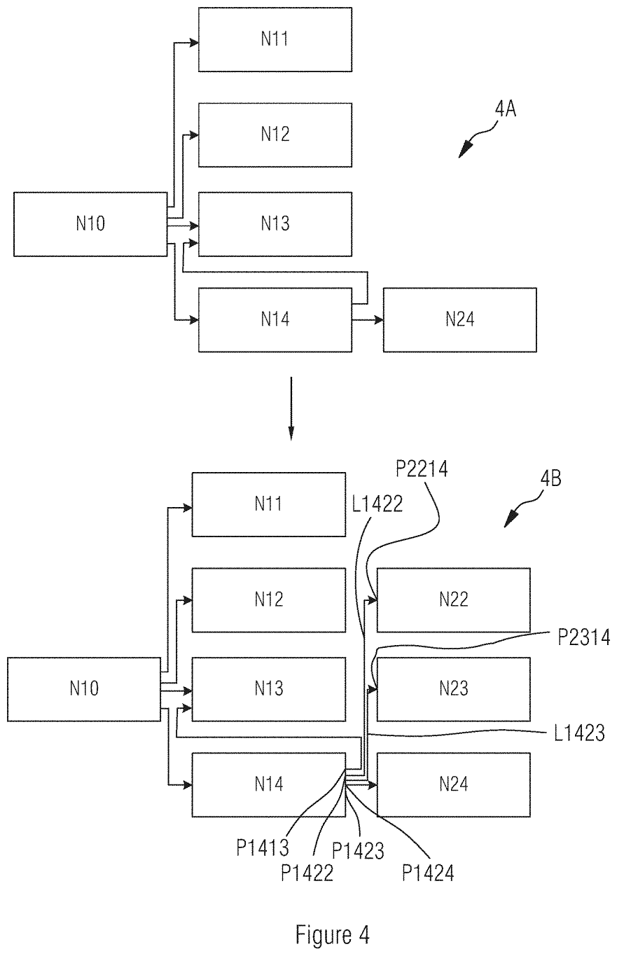

FIG. 4 illustrates an example of a logical model before partial updating and after in accordance with disclosed embodiments. Layout 4A is the layout before partial updating. If the user input is to add two nodes N22 and N23 under N14, then the computer system will receive such input and position the port(s) accordingly.

Layout 4B is the layout after the partial updating. In this example, only the node (N22, N23) affected by the update and the node (N14) connected with the affected ones will be updated. Other nodes N10, N11, N12, N13 and N24, as well as the connecting lines of those nodes are not updated. Further, ports (P1413, P1424) on node N14, which existed prior to N22 and N23, are not changed.

In order to connect N14 and the 2 newly added nodes N22 and N23, it is needed to position 2 new ports on N14. Then the route of the connecting lines connecting N14 and N22, N23 could be followed by the routing algorithm described herein.

In FIG. 4, the new ports P1422 and P1423 on node N14 are located between port P1413 and P1424. Ports (P2214, P2314) on new node N22 and N23 are positioned to make sure the connecting line has the least possible number of segments. As there is already one node N24 connected with N14, N22 and N23 have to be positioned with different levels, so the connecting line L1422 and L1423 are with 3 segments at least.

It is only needed to update the new nodes N22, N23 and the node N14 connected with them, other nodes, connecting lines as well as the existing ports are not affected. The performance is improved with greater efficiency compared to traditionally re-routing of the entire graph.

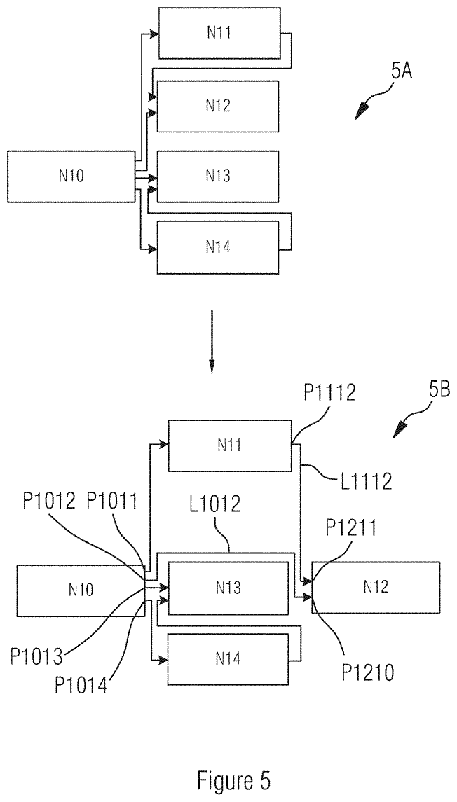

FIG. 5 illustrates an example of a graph before partial updating and after in accordance with disclosed embodiments. Layout 5A is the layout before partial updating. If the user input is to move node N12 to another position, then the computer system will receive such input and position the port(s) found in N12 accordingly.

Ports on other existing nodes that were not changed will not be affected. In layout 5B, node N12 is moved, accordingly nodes N11 and N10 connected with N12 will be affected. However, as there is no new connecting lines added, ports on N10 (P1012, P1011, P1013, P1014), ports on N11 (P1112), ports on N12 (P1211, P1210) are not affected, which means that the position of those ports are kept unchanged. The routing of the connecting lines L1112 and L1012, however, should be updated in accordance with the routing algorithm described later on.

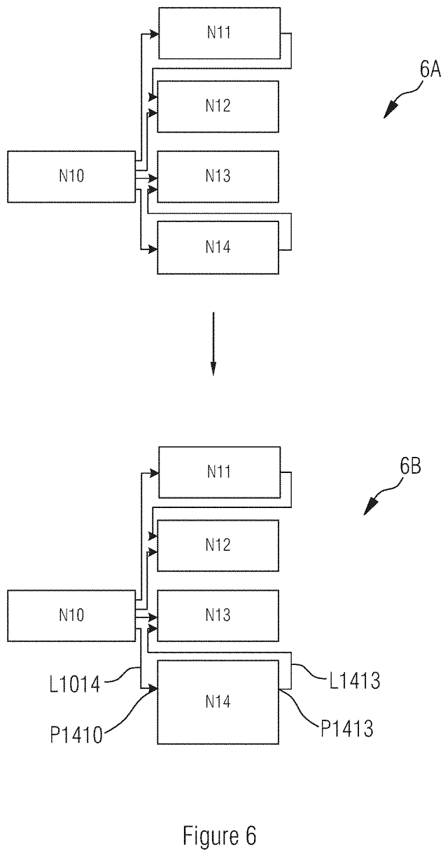

FIG. 6 illustrates an example of a graph before partial updating and after in accordance with disclosed embodiments. Layout 6A is the layout before partial updating. If the user input is to enlarge the size of node N14, then the computer system will receive such input and position the port(s) found within the updated node accordingly.

Ports on other existing nodes that were not changed will not be affected. In layout 6B, node N14 is enlarged, accordingly nodes N10 and N13 connected with N14 may be affected. However, as there is no new connecting lines added, ports on N14 (P1410, P1413), ports on N10, ports on N13 are not affected, which means that the position of those ports are kept unchanged. Further, the connecting lines L1014 and L1413 are not changed.

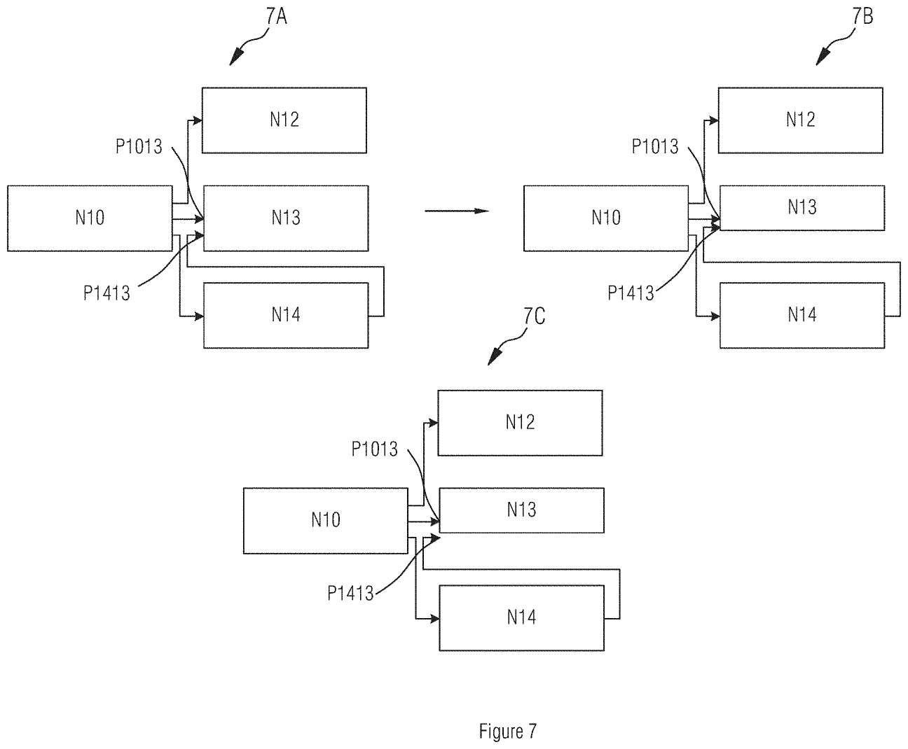

FIG. 7 illustrates an example of a graph before partial updating and after in accordance with disclosed embodiments. Layout 7A is the layout before partial updating. If the user input is to shrink the size of node N13, then the computer system will receive such input and position the port(s) accordingly.

After the shrinking, the size of N13 is smaller than before. Though port P1013 is still on N13, port P1413 as the lowest one is no longer attached to N13 as shown in the layout 7C. Accordingly, the port P1413 will be repositioned on N13 as shown in the layout 7B, so it stays relative to the size of node N13. The position of port P1013 is still kept unchanged. As no new connections are created nor any node is moved due to shrinking, other nodes and connecting lines are not affected, which means that no update is made on them.

Different embodiments are introduced as above to describe the positioning of ports after update. Further details regarding the connection routing will be introduced.

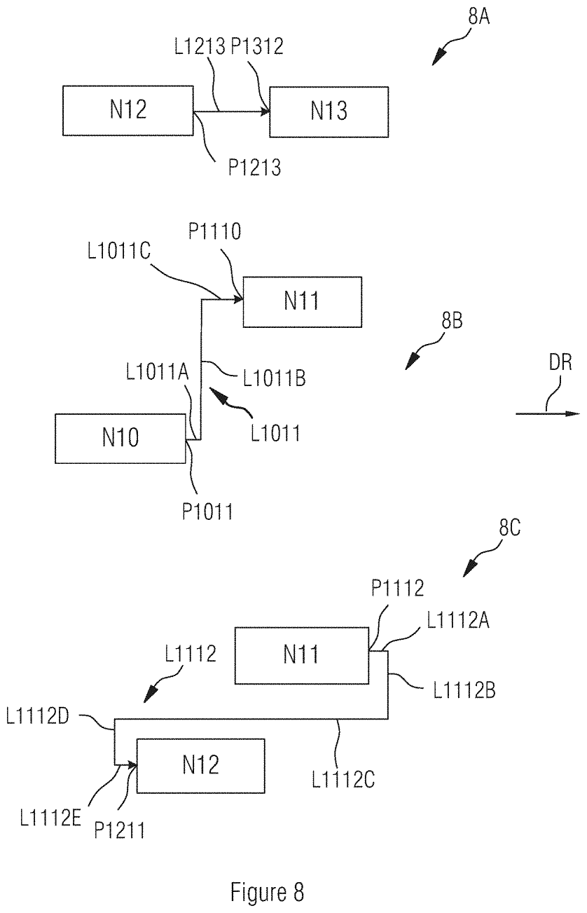

To keep the graph's aesthetics, the connecting line is routed with the priority of 1-segment routing, 3-segment routing and 5-segment routing. If 1-segment routing is not applicable, 3-segment routing will be applied. If 3-segment routing is failed, 5-segment routing should be applied. FIG. 8 illustrates examples of connecting lines in accordance with disclosed embodiments. In layout 8A, port P1213 is connected with port P1312 by a straight line L1213. In layout 8B, port 1011 is connected with port P1110 by L1011, while L1011 comprises 3 segments—L1011A, L1011B and L1011C. L1011A is the straight line extending from the port P1011 of the source node N10, and L1011C is the straight line extending from the port P1110 of the target node N11. L1011B is a straight line vertically connected with L1011A and L1011C. In layout 8C, port P1112 is connected with port P1211 by L1112, while L1112 comprises 5 segments—L1112A, L1112B, L1112C, L1112D and L1112E. L1112A is the straight line extending from the port P1011 of the source node N11, and L1112E is the straight line extending from the port P1211 of the target node N12.

Straight line indicates that the line is expanding in the direction either parallel with the layout extension direction or vertical with the layout extension direction. In FIG. 8, straight line L1213, L1011A, L1011C, L1112A, L1112C, L1112E are parallel with the layout extension direction DR, while straight line L1011B, L1112B, L1112D are vertical with the layout extension direction DR.

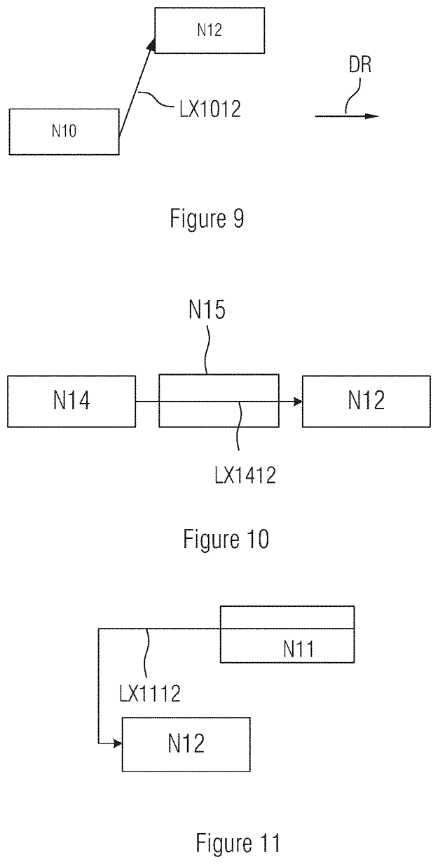

If two ports could be connected with one straight line without overlapping any node, then it selects the 1-segment routing, as layout 8A shown in FIG. 8. However, a line directly connecting two nodes but not in the direction as above described is not a straight line. FIG. 9 illustrates a line LX1012, which is inclined with the layout extension direction DR, is not a straight line. As the 1-segment routing could not be applied without changing the graph's aesthetics, it will try the 3-segment routing. As shown in FIG. 8, layout 8B illustrates the 3-segment routing.

When applying the 3-segment routing, a straight line is extending from the port. The two straight lines will be connected by a third straight line which is vertical with the layout extension direction, without any of the lines overlapping any other node. If there are other existing lines, to avoid the overlapping, the length of the straight line extending from the port could be adjusted.

As shown in FIG. 10, though two nodes could be connected with one straight line LX1412, or as shown in FIG. 11, with a 3-segment line LX1112, the line is overlapping with node N15 in FIG. 10, and overlapping with node N11. In these two scenarios, 5-segment routing can be applied to maintain the graph's aesthetics.

As shown in the layout 8C in FIG. 8, line L1112A is extending from the port P1112 on the source node N11, and line L1112E is extending from the port P1211 on the target node N12. Since there is no straight line that could vertically connect L1112A and L1112E without overlapping any node, the line L1112A will be vertically connected by a line L1112B, and line L1112E will be vertically connected by a line L1112D; finally, line L1112B and L1112E will be further vertically connected by a line L1112C.

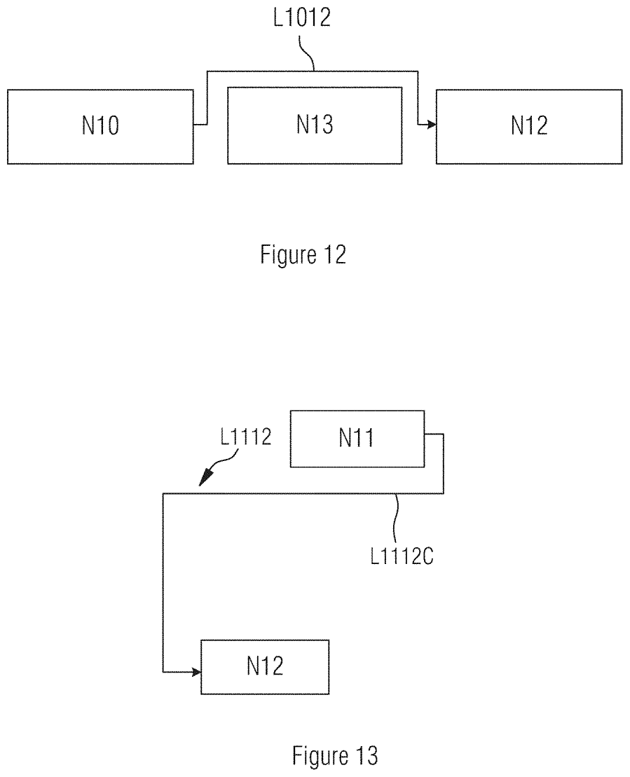

FIG. 12 illustrates another example of this 5-segment routing. Source node N10 and target node N12 are connected by L1012 without overlapping node N13.

As shown in FIG. 13, if the two nodes are positioned by a certain distance, it is suggested to set the line L1112C close to the source node N11. However, it is appreciated that this rule can vary and will be based on the final implementation of the algorithm. For example, Line L1112C can be closer to N12 or spaced exactly between N11 and N12.

Compared to consistently running the routing algorithm for the whole graph of the layout, example embodiments as described could improve the performance, without increasing the computer memory usage.

The graphical elements used in these examples are placed in a structured and/or hierarchical way. It is appreciated that those graphical elements could be positioned based on a process or as desired by a user.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an example embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims.

1. A method for partial updating of a layout of a graph for a plurality of nodes, and respective connections between the plurality of nodes, upon a change to the graph occurring, each node of the plurality of nodes being linked with another node of the plurality of nodes by a respective connecting line, the respective connecting line being attached to respective linked nodes by using a port on a respective one of the linked nodes, the method, performed by a data processing system, comprising:
receiving a user input of an update of the layout, the update including adding a node or a connecting line, moving a node or a connecting line, or resizing a node;
positioning the port only on a node affected by the update received and on a node connected with the node affected by the update received one; and
routing the connecting line, between the node affected by the update received and the node connected, based on the position of the port updated by the positioning.

2. The method of claim 1, wherein keeping an existing position of the port unchanged, on the node affected or on the node connected with the node affected, unless the node affected or the node connected is shrunk with at least one port outside of a boundary of the node affected or the node connected.

3. The method of claim 1, wherein the connecting line is routed with priority of 1-segment routing, 3-segment routing and 5-segment routing.

4. The method of claim 3, wherein the 1-segment routing comprises connecting two ports with one straight line, without the one straight line overlapping any node of the plurality of nodes.

5. The method of claim 3, wherein the 3-segment routing comprises connecting two ports by three straights lines., without any of the three straight lines overlapping any node of the plurality of nodes, one line being vertically connected with another two lines extending from the two ports.

6. The method of claim 3, wherein the 5-segment routing comprises connecting two ports by fine straights lines without any of the fine straights Hines overlapping any node of the plurality of nodes, wherein, one line is vertically connected with two lines, each of the two lines being vertically connected with a line extending from one port.

7. A data processing system comprising:
a processor; and
an accessible memory, the processor configured to partial update a layout of a graph for a plurality of nodes and respective connections between nodes of the plurality of nodes, upon a change to the graph occurring, each node of the plurality of nodes being linked with another node of the plurality of nodes by a respective connecting line, the respective connecting line being attached to the respective linked nodes, by using a port on a respective one of the linked nodes, wherein, the processor is further configured to:
receive a user input of an update of the layout, the update including adding a node or a connecting line, moving a node or a connecting line, or resizing a node;
position the port only on a node affected by the update received and on a node connected with the node affected by the update received; and
route the connecting line between the node affected by the update received and the node connected based on the position of the port updated.

8. The data processing system of claim 7, wherein the an existing position of the port is unchanged on the node affected or on the node connected with the node affected, unless the node affected or the node connected is shrunk with at least one port outside of a boundary of the node affected or the node connected.

9. The data processing system of claim 7, wherein the connecting line is routed with priority of 1-segment routing, 3-segment routing and 5-segment routing.

10. The data processing system of claim 9, wherein the 1-segment routing is connecting two ports with one straight line without the one straight line overlapping any node of the plurality of nodes.

11. The data processing system of claim 9, wherein the 3-segment routing comprises connecting two ports by three straights lines without any of the three straight lines overlapping any node of the plurality of nodes, one line being vertically connected with another two lines extending from the two ports.

12. The data processing system of claim 9, wherein the 5-segment routing comprises connecting two ports by fine straights lines without any of the fine straight lines overlapping any node of the plurality of nodes, wherein, one line is vertically connected with two lines, each of the two lines being vertically connected with a line extending from one port.

13. A non-transitory computer-readable medium encoded with executable instructions that, when executed, cause one or more data processing systems to partially update a layout of a graph for a plurality of nodes and respective connections between the plurality of nodes, upon a change to the graph occurring, each node of the plurality of nodes being linked with another node of the plurality of nodes by a respective connecting line, the respective connecting line being attached to the respective linked nodes, by using a port on one of the respective linked nodes, wherein, the executable instructions, when executed, cause one or more data processing systems to:
receive a user input of an update of the layout, the update including adding a node or a connecting line, moving a node or a connecting line, or resizing a node;
position the port only on the node affected by the update received and on the node connected with the node affected by the update received; and
route the connecting line between the node affected by the update received and the node connected based on the position of the port updated.

14. The non-transitory computer-readable medium of claim 13, wherein an existing position of the port is unchanged on the node affected or on the node connected with the node affected, unless the node affected or the node connected is shrunk with at least one port outside of a boundary of the node affected or the node connected.

15. The non-transitory computer-readable medium of claim 13, wherein the connecting line is routed with the priority of 1-segment routing, 3-segment routing and 5-segment routing.

16. The non-transitory computer-readable medium of claim 13, wherein the 1-segment routing is connecting two ports with one straight line, without the one straight line overlapping any node of the plurality of nodes.

17. The non-transitory computer-readable medium of claim 13, wherein the 3-segment routing comprises connecting two ports by three straights lines without any of the three straight lines overlapping any node of the plurality of node, one line being vertically connected with another two lines extending from the ports.

18. The non-transitory computer-readable medium of claim 13, wherein the 5-segment routing comprises connecting two ports by fine straights lines without any of the fine straights lines overlapping any node of the plurality of nodes, wherein, one line is vertically connected with two lines, each of the two lines being vertically connected with a line extending from one port.

19. The method of claim 2, wherein the connecting line is routed with the priority of 1-segment routing, 3-segment routing and 5-segment routing.

20. The data processing system of claim 8, wherein the connecting line is routed with the priority of 1-segment routing, 3-segment routing and 5-segment routing.
